(19) United States
(12) Patent Application Publication
(10) Pub. No.: US 2001/0039135 A1
(43) Pub. Date: Nov. 8, 2001

(54) X-ray fluorescence analysis apparatus

(76) Inventors: Koichi Tamura, Chiba-shi (JP); Mitsuo Naito, Chiba-shi (JP)

Correspondence Address: ADAMS & WILKS, 31st Floor, 50 Broadway, New York, NY, 10004, US

(21) Appl. No.: 09/827,122

(22) Filed: Apr. 5, 2001

(30) Foreign Application Priority Data
Apr. 6, 2000 (JP) 2000-104847

(51) Int. Cl. H01R 13/44

(52) U.S. Cl. 439/142

(57) ABSTRACT

The present invention sets out to provide X-ray fluorescence analysis apparatus having a safely detachable mechanism where a high-voltage cable cannot be removed during application of a high-voltage. A cover with a channel through which a cable passes is provided at an opening of a housing for connecting a high-voltage cable. A mechanism for detecting open and closed states of this cover and cutting off a high-voltage is then provided.

### BACKGROUND OF THE INVENTION

The present invention relates to an X-ray fluorescence analysis apparatus for carrying out non-destructive elementary analysis, and more particularly relates to an X-ray fluorescence analysis apparatus divided up into a measuring unit housing and X-ray tube and a power supply unit housing a high-voltage power supply.

X-ray fluorescence analysis apparatus where a measuring unit housing an X-ray tube and a power supply unit housing a high-voltage power supply are separate are well known in the related art. In particular, with portable X-ray fluorescence analysis apparatus, the apparatus are divided to make the size and weight of each individual unit smaller and therefore easier to carry about. Further, on the other hand, with X-ray fluorescence analysis apparatus with an opening on the outer side of the apparatus from which X-rays are radiated, it is preferable in particular for a measuring unit housing to be small and lightweight in order to move a measuring unit housing containing a tube and position this housing at a region of a material it is desired to measure.

In order to make the measuring unit housing small and lightweight, tests have been carried out where a high-voltage power supply for applying a high-voltage to an X-ray tube is separated from the measuring unit, with the measuring unit housing and the high-voltage power supply being connected by a high-voltage cable.

With the apparatus configured in the above manner, the high-voltage power supply is located in an exposed manner independent of the measuring unit. If the high-voltage cable then becomes detached during application of a high-voltage, damage to and electrification of the X-ray tube and the high-voltage supply may occur.

Therefore, in order to resolve the aforementioned problem, the present invention sets out to provide x-ray fluorescence analysis apparatus having a safely detachable mechanism where a high-voltage cable cannot be removed during application of a high-voltage.

### SUMMARY OF THE INVENTION

The present invention adopts the following means in order to resolve the aforementioned problems.

In the present invention, an X-ray fluorescence analysis apparatus comprises: a first housing for housing an X-ray tube for irradiating a sample to be measured with primary X-rays; a second housing for housing a high-voltage power supply for supplying a high-voltage to the X-ray tube; and a high-voltage cable connecting the X-ray tube and the high-voltage power supply, wherein one end of the high-voltage cable is connected to the high-voltage connector, the high-voltage power supply is provided with a connection unit corresponding to the high-voltage connector, the second housing for housing the high-voltage power supply is provided with an opening for connecting the high-voltage connector to the connection unit, an opening/closing cover provided at the opening and formed with a hole of a diameter capable of allowing the high-voltage cable to pass and of a diameter where a finger cannot be inserted when the high-voltage cable passes through or formed with a channel of a diameter capable of allowing the high-voltage cable to pass and of a diameter where a finger cannot be inserted when the high-voltage cable passes through, a microswitch for detecting whether the cover is open or closed is provided at the second housing for housing the high-voltage power supply, and a state of the microswitch operates in unison with an interlocking mechanism for generating a high-voltage of the high-voltage power supply.

Here, the X-ray tube and high-voltage power supply are connected by a high-voltage cable but with the aforementioned portable or open-type apparatus, the the housing containing the X-ray tube is made as small and lightweight as possible in order to be located close to the subject to be measured and the heavy high-voltage power supply is provided as a separate housing, with it being desirable to make the intervening high-voltage cable long. However, having a long high-voltage cable in a continually connected state is detrimental to handling and also troublesome with respect to transportation, and structures where the high-voltage cable is detachable at one or more locations using a high-voltage connector are common.

In the present invention it is assumed that high-voltage connectors are provided at at least one location on the high-voltage power supply unit. As with other electrical parts and substrates, etc., the high-voltage power supply unit is housed in the housing in such a manner that touching from outside is not possible and the high-voltage connector portion is provided with an opening in such a manner that a high-voltage cable can be connected from outside of the housing.

A typical form that a high-voltage connector takes is that a lead is outputted from a high-voltage cable. This lead is then inserted into a receptacle of a high-voltage power supply. A cap with a hole allowing the cable to pass and threading cut on an inner surface is screwed into the receptacle so that the cable is fixed. It is therefore preferable for an opening of a size sufficient to enable the implementation of this screwing-in operation to be made in the housing.

At this time, it is also possible for the relationship between the lead and the receptacle to be reversed and for bolts to be employed as the fixing method rather than screws but it is preferable for the size of the opening to be sufficiently large so as to enable connection of the high-voltage connector.

Further, an opening and closing type cover is provided to cover over the opening. A channel for allowing the high-voltage cable to pass is cut in such a manner that the cover can be closed with the high-voltage cable inserted in the high-voltage power supply. The width of this channel is larger than the diameter of the high-voltage cable but a gap between the high-voltage cable and the cover is made narrow to an extent that a finger will not fit into the gap so that the high-voltage connector cannot be taken out when the cover is closed. The channel for allowing the high-voltage cable to pass may also be a hole rather than a channel. In this case, the diameter of the hole is larger than the diameter of the high-voltage cable and the gap between the high-voltage cable and the hole is narrow to an extent that a finger cannot be inserted.

A microswitch for detecting opening and closing of the cover is provided at the housing in the vicinity of this opening and the open/closed state of the switch operates electrically or using software in unison with the turning on and off of the high-voltage power supply, i.e. a high-voltage is generated by the high-voltage power supply only when it is detected that the cover is closed and is no longer generated when it is detected that the cover is closed.

A high-voltage power supply interlocking mechanism or a power supply circuit driving a high-voltage power supply may be employed to operate in unison with the opening and closing states of the microswitch.

The above configuration is safe because the high-voltage power supply is cut when it is intended to detach the high-voltage cable and open the cover. Further, the high-voltage cable cannot be detached because the high-voltage connector cannot be touched with the cover in a closed state.

### BRIEF DESCRIPTION OF THE DRAWINGS.

FIG. 1A is a schematic view showing an apparatus constituting an embodiment of the present invention;

FIG. 1B is a schematic view showing an apparatus constituting an embodiment of the present invention;

FIG. 2 is a view illustrating a high-voltage connection unit of this apparatus;

FIG. 3 is a schematic view showing an apparatus with a cover having a hole;

### DETAILED DESCRIPTION OF THE PREFERRED EMBODIMENT

### First Embodiment

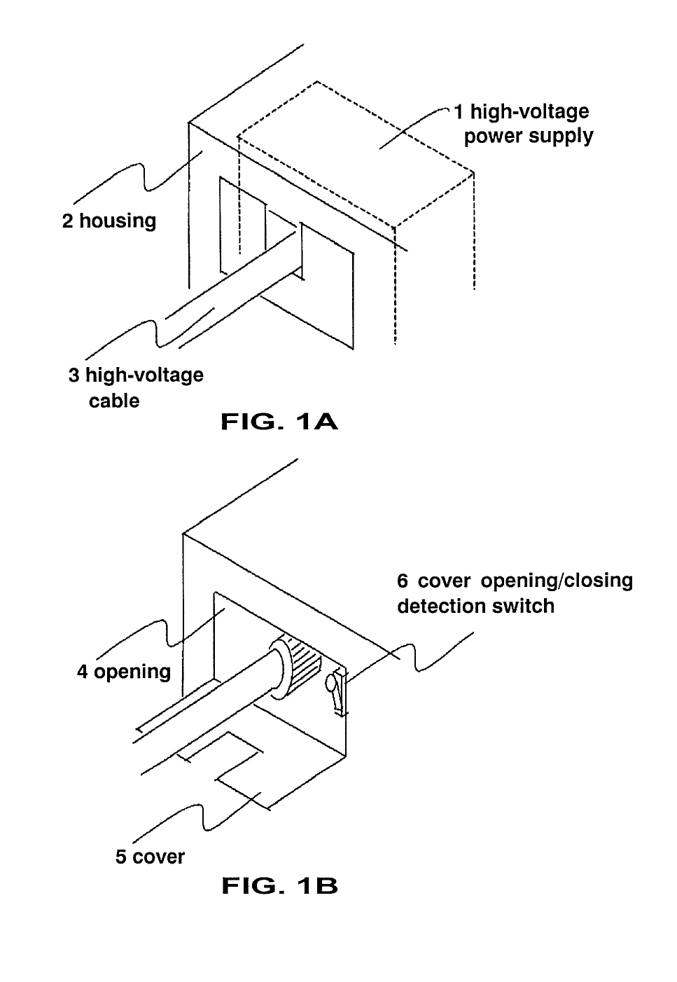

The following is a description, with reference to FIGS. 1A and 1B, of a preferred embodiment of the present invention.

In this embodiment, a high-voltage power supply 1 for supplying a high-voltage to an X-ray tube, and other power supplies and substrates etc., are housed in a housing 2.

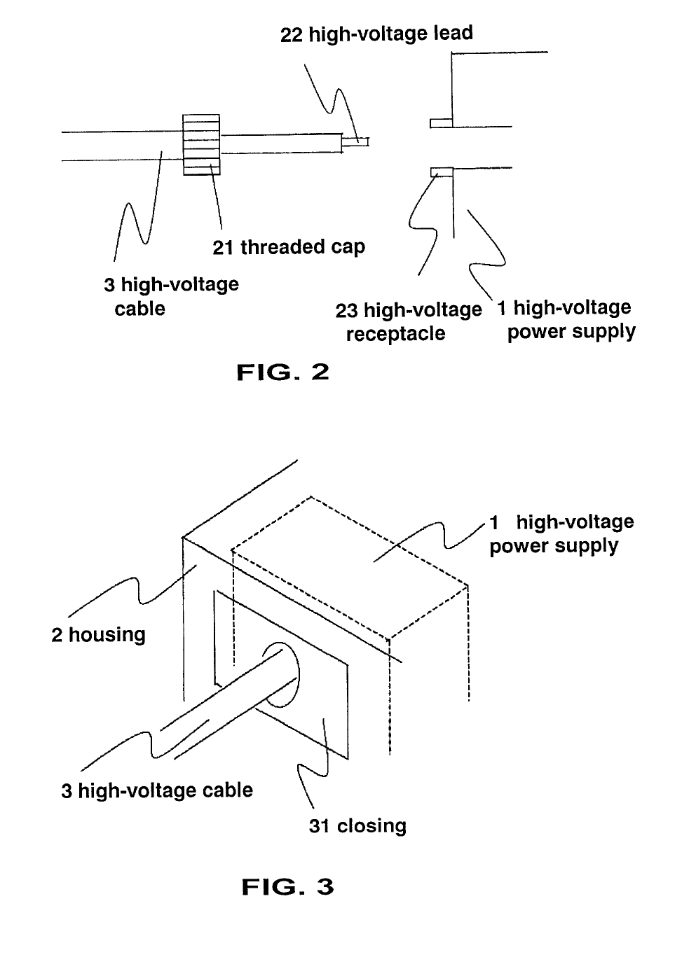

The high-voltage cable 3 connecting the X-ray tube and the high-voltage power supply is provided at one end with a high-voltage connector so as to be detachable. An example of this kind of detachable high-voltage connector is shown in FIG. 2.

A high-voltage lead 22 for connecting with a high-voltage is formed at an end of the high-voltage cable 3 and a corresponding high-voltage receptacle 23 is formed at the high-voltage power supply 1. When connecting, the high-voltage lead 22 is inserted into the high-voltage receptacle 23 and a threaded cap 21 is threaded into a corresponding portion of the high-voltage receptacle 23 so as to become fixed.

The other end of the high-voltage cable 3 is connected directly to the X-ray tube or may be connected via one or more high-voltage connectors.

The high-voltage cable 3 is provided with an opening 4 at the housing 2 in order to carry out attaching and detaching of the high-voltage power supply I. The size of the opening 4 can be any shape providing that the opening 4 is sufficiently large to perform the aforementioned attaching and detaching operation.

An opening and closing cover 5 for covering the opening 4 is fitted to the housing 2. A channel is formed in the cover 5 so that closing can be achieved with the high-voltage cable 3 in a connected state. The channel may be rectangular or U-shaped as shown in the drawings, and the size of the channel must be larger than the diameter of the high-voltage cable 3 so that the high-voltage cable 3 may pass through. When the cover 5 is closed, the gap between the high-voltage cable and the channel of the lid is narrow to the extent that a finger cannot be inserted therebetween and the high-voltage connector therefore cannot be detached.

In this case a channel is formed in the cover 5, but a hole may also be formed in a cover 31 as shown in FIG. 3. At this time, it is necessary for the size of the hole to be larger than the maximum diameter of the high-voltage cable including accessories such as the threaded cap etc. so that the high-voltage cable may be allowed to pass so that the gap between the high-voltage cable and the hole when the cover is closed is narrow to an extent that a finger cannot enter.

In FIGS. 1A and 1B, the cover 3 is fitted to the housing 2 using a hinge etc., so that opening and closing is possible but the use of bolts and screws in the method for fixing the cover may hinder this opening and closing.

A cover opening/closing detection switch 6 is fitted in the vicinity of the opening 4 of the housing 2 and detects whether the cover 5 is open or closed. This switch may be a microswitch, a pressure sensor, a photoelectric sensor, or any switch capable of detecting whether the cover is open or closed.

A connection point of the cover opening/closing detection switch 6 operates in unison with a power supply circuit of the high-voltage power supply 1, i.e. when the cover is detected as being open, the power supply circuit of the high-voltage power supply 1 is cut off so that a high-voltage is not generated. When an interlock mechanism is provided to inhibit the application of a high-voltage to the high-voltage power supply 1, the cover opening/closing detection switch 6 and the interlocking mechanism of the high-voltage power supply 1 may operate in unison, i.e. when the cover is detected as being open, the interlocking of the high-voltage power supply 1 operates and a high-voltage is not generated.

It is possible to have the connection point of the cover opening/closing detection switch 6 and the power supply circuit of the high-voltage power supply 1 operate in unison via software or via electrical means employing relays.

What is claimed is:

1. X-ray fluorescence analysis apparatus comprising:
a first housing for housing an X-ray tube for irradiating a sample to be measured with primary X-rays;
a second housing for housing a high-voltage power supply for supplying a high-voltage to the X-ray tube;
and a high-voltage cable connecting the X-ray tube and the high-voltage power supply,
wherein one end of the high-voltage cable is a high-voltage connector,
the high-voltage power supply is provided with a connection unit corresponding to the high-voltage connector,
the second housing for housing the high-voltage power supply is provided with an opening for connecting the high-voltage connector to the connection unit,
an opening/closing cover provided at the opening and formed with a hole of a diameter capable of allowing the high-voltage cable to pass and of a diameter where a finger cannot be inserted when the high-voltage cable passes through or formed with a channel of a diameter capable of allowing the high-voltage cable to pass and of a diameter where a finger cannot be inserted when the high-voltage cable passes through,
a microswitch for detecting whether the cover is open or closed is provided at the second housing for housing the high-voltage power supply, and
a state of the microswitch operates in unison with an interlocking mechanism for generating a high-voltage of the high-voltage power supply.
